(19) United States
(12) Patent Application Publication
(10) Pub. No.: US 2010/0111585 A1
(43) Pub. Date: May 6, 2010

(54) Light-emitting keyboard

(75) Inventor: Ching Cheng Tsai, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: CHICONY ELECTRONICS CO., LTD, Taipei Hsien (TW)

(21) Appl. No.: 12/453,853

(22) Filed: May 26, 2009

(30) Foreign Application Priority Data
Oct. 30, 2008 (TW) 97141804

(51) Int. Cl. B41J 5/00

(52) U.S. Cl. 400/472

(57) ABSTRACT

A light-emitting keyboard comprises: a light guide having a light entrance surface, a bottom surface and a light exit surface; a light source provided on one side of the light entrance surface of the light guide; a first reflector disposed underneath the bottom surface of the light guide; a second reflector disposed on top of the light exit surface of the light guide; a membrane circuit board disposed on top of the second reflector; an elastic contact body provided on the membrane circuit board; a supporting plate disposed on top of the membrane circuit board; a scissor assembly engaged with the supporting plate and disposed thereon; and a keycap supported by the scissor assembly; wherein the second reflector permits a portion of the light emitted from the light exit surface of the light guide to pass therethrough and reflects another portion of the light back towards the light exit surface of the light guide; and wherein the light guide is provided with a second opening corresponding to the elastic contact body, with the circumference of the second opening being coated with a light reflecting material.

### BACKGROUND OF THE INVENTION

1. Field of the Invention

The present invention relates to a keyboard, and more particularly, to a keyboard that facilitates increasing the luminescent efficiency.

2. Description of the Related Art

With the popularity of computer, users not only pursue better computer efficiency but also pay more attention to the function and design of computer accessories such as mouse and keyboard. As computer has become an indispensable device in nearly every aspect of modern life from telecommunication, commerce, editing to graphics design, some manufacturers equip keyboard, one of the most important input devices for computer, with backlit keys so that the user can perform input tasks under inadequate lighting. Besides, the back lighting makes the keyboard look fancy.

Referring to the description on a light-emitting keyboard of ROC Publication No. 509955, the keyboard disposed on a bottom casing comprises: a base plate, with a plurality of fixations disposed thereon; a membrane circuit board; at least one keycap; at least one elastic member; and at least one scissor structure. An end of the scissor structure is connected to said plurality of fixations on the base plate while the other end thereof is connected to the keycap such that the keycap may move upwardly and downwardly relative to the base plate. Said at least one elastic member is disposed between the membrane circuit board and the keycap to support the keycap in an upward or vertical direction.

The bottom surface of the light guide is provided with a plurality of light reflecting portions corresponding to the transparent spacer layer such that the light originated from the light source and entering the light guide is refracted when reaching the light reflecting portions, and then said light is reflected to the keyboard portion to reinforce the luminescent efficiency of the key. The light reflecting portions may be formed by printing a plurality of reflecting dots onto the bottom surface of the light guide Alternatively, the light reflecting portions may be formed integrally with the bottom surface of the light guide, creating a rough reflecting surface.

In the aforementioned prior art, the light is refracted and then reflected towards the keyboard portion to illuminate the key when reaching the light reflecting portions. However, the keyboard illuminated in this way has the drawback of low luminescent efficiency and needs to be improved.

### SUMMARY OF THE INVENTION

An object of the present invention is to provide a light-emitting keyboard, where the light guide is provided with a second opening corresponding to the elastic contact body, and the conical surface of the second opening is coated with a light reflecting material. After entering the light guide via the light entrance surface thereof, the light originated from the light source is reflected or refracted repeatedly by the first and second reflectors while the second opening having the light reflecting material coated thereon facilitates concentrating the light that passes therethrough in a vertical direction towards the keycap such that the luminescent efficiency of the light-emitting keyboard may be further reinforced.

The light-emitting keyboard that achieves the abovementioned objects comprises: a light guide having a light entrance surface, a bottom surface and a light exit surface; a light source provided on one side of the light entrance surface of the light guide; a first reflector disposed underneath the bottom surface of the light guide to prevent the light emitted by the light source from escaping from the bottom surface of the light guide by reflecting said light towards the light exit surface of the light guide; a second reflector disposed on top of the light exit surface of the light guide; a membrane circuit board disposed on top of the second reflector; an elastic contact body provided on the membrane circuit board; a supporting plate disposed on top of the membrane circuit board, the supporting plate further including a first opening corresponding to the elastic contact body and a plurality of first and second fixation brackets adjacent to the first opening thereon; a scissor assembly engaged with the supporting plate and disposed thereon; and a keycap supported by the scissor assembly; wherein the second reflector permits a portion of the light emitted from the light exit surface of the light guide to penetrate therethrough and reflects another portion of the light back towards the light exit surface of the light guide; and wherein the light guide is provided with a second opening corresponding to the elastic contact body, the circumference of the second opening being coated with a light reflecting material.

Preferably the light source is controlled by a base circuit board and provided adjacent to a lateral side of the light guide.

Preferably the light entrance surface and the bottom surface of the light guide adjoin to each other and the bottom surface of the light guide is opposed to the light exit surface of the light guide such that the light originated from the light source may enter at the light entrance surface of the light guide and radiate out of the light guide via the light exit surface thereof.

Preferably the second opening is a conical opening, and the conical surface of the second opening is coated with the light reflecting material.

Preferably the light reflecting material is printed on or formed integrally with the conical surface of the second opening.

Preferably the light guide further includes a first lateral side, a second lateral side and a third lateral side, the first and third lateral sides being perpendicular to the light entrance surface of the light guide and the second lateral side being parallel to the light entrance surface of the light guide; wherein the first, second and third lateral sides are coated with a light reflecting material.

Preferably the light reflecting material is printed on or formed integrally with the first, second and third lateral sides.

A light-emitting keyboard that achieves the abovementioned objects comprises: a light guide having a light entrance surface, a bottom surface and a light exit surface; a light source provided on one side of the light entrance surface of the light guide; a membrane circuit board disposed on top of the light guide; an elastic contact body provided on the membrane circuit board; a supporting plate disposed on top of the membrane circuit board, the supporting plate further including a first opening corresponding to the elastic contact body and a plurality of first and second fixation brackets adjacent to the first opening thereon; a scissor assembly engaged with the supporting plate and disposed thereon; and a keycap supported by the scissor assembly; wherein the bottom surface and the light exit surface of the light guide are coated with a light reflecting material such that the bottom surface of the light guide may reflect the light originated from the light source to enter the light guide and the light exit surface of the light guide may permit a portion of the light emitted therefrom to pass therethrough and reflect another portion of the light back towards the light guide; and wherein the light guide is provided with a second opening corresponding to the elastic contact body, the circumference of the second opening being coated with a light reflecting material.

Preferably the light source is controlled by a base circuit board and provided adjacent to a lateral side of the light guide.

Preferably the light entrance surface and the bottom surface of the light guide adjoin to each other and the bottom surface of the light guide is opposed to the light exit surface of the light guide such that the light originated from the light source may enter at the light entrance surface of the light guide and radiate out of the light guide via the light exit surface thereof.

Preferably the second opening is a conical opening and the conical surface of the second opening is coated with the light reflecting material.

Preferably the light reflecting material is printed on or formed integrally with the conical surface of the second opening.

Preferably the light guide further includes a first lateral side, a second lateral side and a third lateral side, the first and third lateral sides being perpendicular to the light entrance surface of the light guide and the second lateral side being parallel to the light entrance surface of the light guide; wherein the first, second and third lateral sides are coated with a light reflecting material.

Preferably the light reflecting material is printed on or formed integrally with the first, second and third lateral sides.

Preferably the light reflecting material is printed on or formed integrally with the bottom surface and the light exit surface of the light guide.

### BRIEF DESCRIPTION OF THE DRAWINGS

FIG. 1 is an exploded view showing the first embodiment of a light-emitting keyboard of the present invention.

FIG. 2 is a sectional view showing the first embodiment of a light-emitting keyboard of the present invention.

FIG. 3 is a schematic representation showing a light guide incorporated in the first embodiment of a light-emitting keyboard of the present invention.

FIG. 4 is an exploded view showing the second embodiment of a light-emitting keyboard of the present invention.

FIG. 5 is a schematic representation showing a light guide incorporated in the second embodiment of a light-emitting keyboard of the present invention.

### DETAILED DESCRIPTION OF THE PREFERRED EMBODIMENTS

The present invention will be described more fully hereinafter with reference to the accompanying drawings, in which preferred embodiments of the invention are shown. This invention may, however, be embodied in many different forms and should not be construed as limitations to the embodiments set forth herein; rather, these embodiments are provided so that this disclosure will be thorough and complete, and will fully convey the scope of the invention to those skilled in the art.

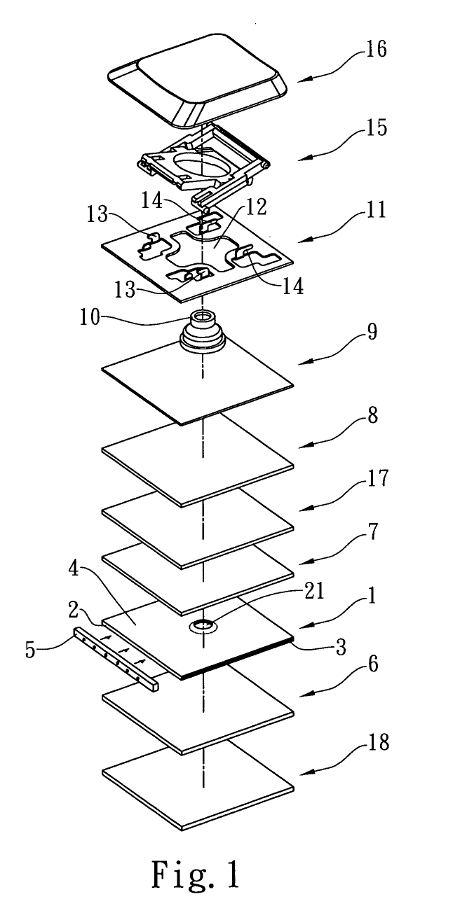

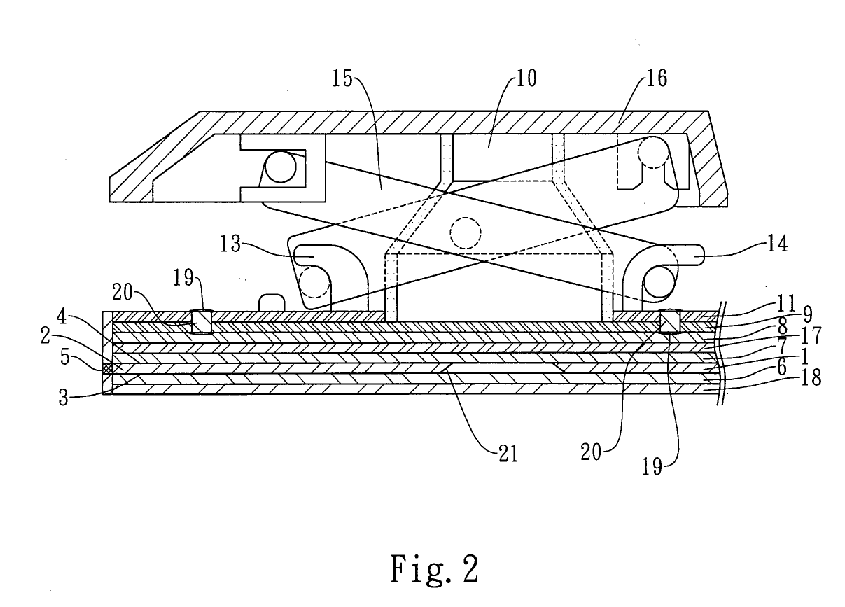

FIG. 1 and FIG. 2 representatively show an exploded view and a sectional view of a light-emitting keyboard according to the first embodiment of the present invention. For illustration purposes, a person skilled in the art shall understand that a single key unit of the light-emitting keyboard illustrated in the drawings represents a group of similar key units on the keyboard. Modules similar to those equipped in a keyboard, such as top casing and bottom casing, are omitted for illustration purposes.

A light-emitting keyboard of the present invention comprises: a light guide 1 having a light entrance surface 2, a bottom surface 3 adjoining to the light entrance surface 2 and a light exit surface 4 opposed to the bottom surface 3; a light source 5 controlled by a base circuit board 18 and provided on one side of the light entrance surface 2 of the light guide 1; a first reflector 6 disposed underneath the bottom surface 3 of the light guide 1; a second reflector 7 disposed on top of the light exit surface 4 of the light guide 1; a water-resistant layer 17 disposed on top of the second reflector 7; a reinforcement board 8 disposed on top of the water-resistant layer 17; a membrane circuit board 9 disposed on top of the reinforcement board 8, the membrane circuit board 9 being provided with an elastic contact body 10; a supporting plate 11 disposed on top of the membrane circuit board 9, the supporting plate 11 further including a first opening 12 corresponding to the elastic contact body 10 and a plurality of first and second fixation brackets 13 and 14 adjacent to the first opening 12 thereon; a scissor assembly 15 engaged with the supporting plate 11 and disposed thereon; and a keycap 16 supported by the scissor assembly 15; wherein, the light guide 1 is provided with a second opening 21 corresponding to the elastic contact body 10. In this embodiment, it is preferable that the second opening 21 is a conical opening and the conical surface of the second opening 21 is coated with a light reflecting material.

The lower ends of the scissor assembly 15 are engaged with the plurality of first and second fixation brackets 13 and 14 on the supporting plate 11 respectively, and the upper ends of the scissor assembly 15 are received at a bottom of the keycap 16 such that the elastic contact body 10 disposed on the membrane circuit board 9 may pass through the first opening 12 of the supporting plate 11 and the scissor assembly 15 respectively to engage with the bottom of the keycap 16. During operation, as the keycap 16 is pressed downwardly, the elastic contact body 10 may be elastically deformed to press or touch an electrical switch on the membrane circuit board 9 to generate or activate a corresponding signal.

The light originated from the light source 5 may enter the light guide 1 via the light entrance surface 2 thereof and then be radiated in a vertical upward direction via the light exit surface 4 of the light guide 1. A portion of the light originated from the light source 5 may sequentially pass through the second reflector 7, the water-resistant layer 17, the reinforcement board 8, the membrane circuit board 9, the supporting plate 11, the scissor assembly 15 and then reach the bottom of the keycap 16 such that the keycap 16 may be illuminated to a desired level. Furthermore, another portion of the light originated from the light source 5 may be reflected back towards the light exit surface 4 of the light guide 1 by the second reflector 7, and then the portion of the light may again be radiated in a vertical upward direction towards the keycap 16 to illuminate the keycap 16 and further reinforce the luminescent efficiency.

As the light emitted from the light source 5 enters the light guide 1 via the light entrance surface 2 thereof, a portion of the light that escapes from the bottom surface 3 of the light guide 1 may be reflected upward by the first reflector 6 and then be radiated out of the light guide 1 via the light exit surface 4 thereof to illuminate the keycap 16. It may be understood that the portion of the light reflected by the first reflector 6 may travel in a vertical upward direction passing through the components and structures configured between the first reflector 6 and the keycap 16, including the light guide 1, the second opening 21 of the light guide 1, the second reflector 7, the water-resistant layer 17, the reinforcement board 8, the membrane circuit board 9, the elastic contact body 10, the supporting plate 11 and the scissor assembly 15; wherein the conical surface of the second opening 21 is coated with the light reflecting material thereby to prevent the light leakage problem and concentrate the light such that the luminescent efficiency may be further reinforced; and wherein the light reflecting material may be printed on or formed integrally with the conical surface of the second opening 21.

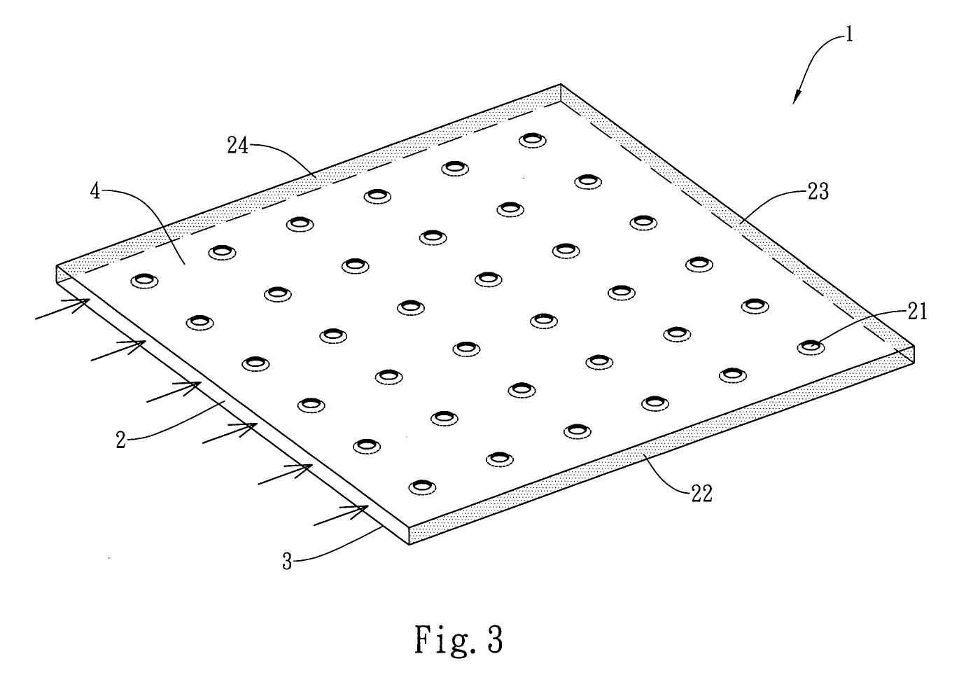

FIG. 3 is a schematic representation showing a light guide 1 incorporated in the first embodiment of a light-emitting keyboard of the present invention. In this embodiment, the light guide 1 is shown as having a generally square shape, but its actual shape can vary, depending on the application. In addition, the light guide 1 is provided with a plurality of second openings 21. It is to be understood that the relative locations of the plurality of second openings 21 shown in FIG. 3 are given only as exemplary, and the actual location of the second opening 21 is arranged corresponding to the elastic contact body 10.

The light guide 1 further includes a first lateral side 22, a second lateral side 23 and a third lateral side 24, the first and third lateral sides 22 and 24 being perpendicular to the light entrance surface 2 and the second lateral side 23 being parallel to light entrance surface 2. The first, second and third lateral sides 22, 23 and 24 are coated with a light reflecting material to prevent the light (indicated by the arrows shown in FIG. 3) that enters at the light entrance surface 2 of the light guide 1 from leaking therefrom so as to increase the amount of light available and further reinforce the luminescent efficiency; wherein the light reflecting material may be printed on or formed integrally with the first, second and third lateral sides 22, 23 and 24.

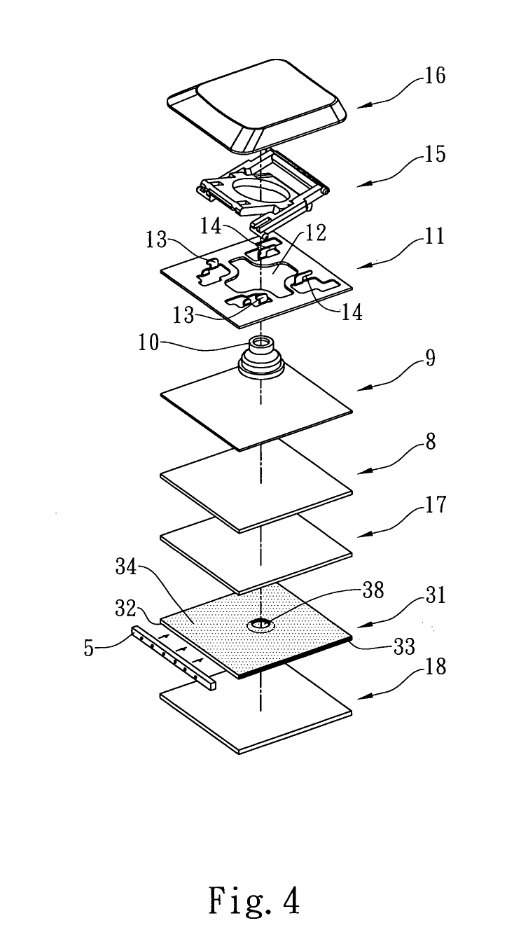

FIG. 4 is an exploded view showing the second embodiment of a light-emitting keyboard of the present invention. In this embodiment, the light-emitting keyboard of the present invention comprises: a light guide 31 having a light entrance surface 32, a bottom surface 33 and a light exit surface 34; a light source 5 provided on one side of the light entrance surface 32 of the light guide 31; a water-resistant layer 17 disposed on top of the light guide 31; a reinforcement board 8 disposed on top of the water-resistant layer 17; a membrane circuit board 9 disposed on top of the reinforcement board 8; an elastic contact body 10 provided on the membrane circuit board 9; a supporting plate 11 disposed on top of the membrane circuit board 9, the supporting plate 11 further including a first opening 12 corresponding to the elastic contact body 10 and a plurality of first and second fixation brackets 13 and 14 adjacent to the first opening 12 thereon; a scissor assembly 15 engaged with the supporting plate 11 and disposed thereon; and a keycap 16 supported by the scissor assembly 15; wherein the bottom surface 33 and the light exit surface 34 of the light guide 31 are coated with a light reflecting material; and wherein the light reflecting material may be printed on or formed integrally with the bottom surface 33 and the light exit surface 34 of the light guide 31.

The bottom surface 33 of the light guide 31 reflects the light originated from the light source 5 to enter the light guide 31 while the light exit surface 34 of the light guide 31 permits a portion of the light emitted therefrom to pass therethrough and reflects another portion of the light back towards the light guide 31. Furthermore, the light guide 31 is provided with a second opening 38 corresponding to the elastic contact body 10. It is preferable that the second opening 38 is a conical opening and the conical surface of the second opening 38 is coated with a light reflecting material; wherein the light reflecting material may be printed on or formed integrally with the conical surface of the second opening 38.

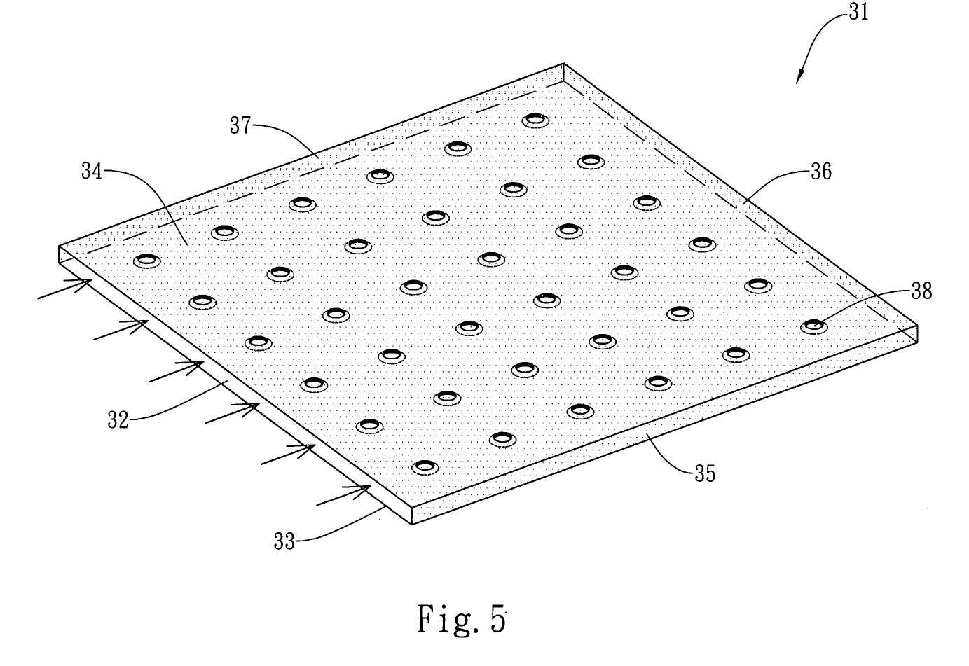

FIG. 5 is a schematic representation showing a light guide 31 incorporated in the second embodiment of a light-emitting keyboard of the present invention. In this embodiment, the light guide 31 is shown as having a generally square shape, but its actual shape can vary, depending on the application. In addition, the light guide 31 is provided with a plurality of second openings 38. It is to be understood that the relative locations of the plurality of second openings 38 shown in FIG. 5 are given only as exemplary, and the actual location of the second opening 38 is arranged corresponding to the elastic contact body 10.

The light guide 31 further includes a first lateral side 35, a second lateral side 36 and a third lateral side 37, the first and third lateral sides 35 and 37 being perpendicular to the light entrance surface 32 and the second lateral side 36 being parallel to the light entrance surface 32; wherein the first, second and third lateral sides 35, 36 and 37 are coated with a light reflecting material; and wherein the light reflecting material may be printed on or formed integrally with the first, second and third lateral sides 35, 36 and 37.

The bottom surface 33, the light exit surface 34, and the first, second and third lateral sides 35, 36 and 37 are coated with the light reflecting material so as to retain as much of the light originated from the light source 5 and entering the light entrance surface 32 as possible within the light guide 31; wherein as the conical surface of the second opening 38 is coated with the light reflecting material to prevent the light leakage problem, the light within the light guide 31 is more highly concentrated, and then the light will be radiated in a vertical upward direction passing through the components and structures configured between the light guide 31 and the keycap 16, including the water-resistant layer 17, the reinforcement board 8, the membrane circuit board 9, the elastic contact body 10, the supporting plate 11 and the scissor assembly 15, to reinforce the luminescent efficiency of the light-emitting keyboard.

### Merits of the Present Invention

Merits of the present invention may be summarized as follows; however, it can be understood that the merits recited herein are to better illustrate the technical features of the present invention and shall not be construed as a limitation to the present invention.
1. As the light guide is provided with a second opening corresponding to the elastic contact body and the conical surface of the second opening is coated with the light reflecting material, the light can be reflected more efficiently so as to increase the luminescent efficiency of the light-emitting keyboard.
2. The first, second and third lateral sides of the light guide are coated with the light reflecting material to prevent the light from leaking to the ambient environment such that the light can be fully exploited to reinforce the luminescent efficiency of the light-emitting keyboard of the present invention.
3. The light exit surface and the bottom surface of the light guide are coated with the light reflecting material to prevent the light from leaking to the ambient environment such that the light can be fully exploited to illuminate the light-emitting keyboard of the present invention.

While this invention has been described by way of examples and in terms of preferred embodiments, it is to be understood that this invention is not limited hereto, and that various changes, substitutions, and alterations can be made herein without departing from the spirit and scope of this invention as defined by the appended claims. Please refer to the claims for the coverage of the rights of the present invention.

What is claimed is:

1. A light-emitting keyboard, comprising:
a light guide having a light entrance surface, a bottom surface and a light exit surface;
a light source provided on one side of the light entrance surface of the light guide;
a first reflector disposed underneath the bottom surface of the light guide to reflect the light originated from the light source to enter the light guide;
a second reflector disposed on top of the light exit surface of the light guide;
a membrane circuit board disposed on top of the second reflector;
an elastic contact body provided on the membrane circuit board;
a supporting plate disposed on top of the membrane circuit board, the supporting plate further including a first opening corresponding to the elastic contact body and a plurality of first and second fixation brackets adjacent to the first opening thereon;
a scissor assembly engaged with the supporting plate and disposed thereon; and
a keycap supported by the scissor assembly;
wherein the second reflector permits a portion of the light emitted from the light exit surface of the light guide to pass therethrough and reflects another portion of the light back towards the light exit surface of the light guide; and wherein the light guide is provided with a second opening corresponding to the elastic contact body, the circumference of the second opening of the light guide being coated with a light reflecting material.

2. The light-emitting keyboard according to claim 1, wherein the light source is controlled by a base circuit board and provided adjacent to a lateral side of the light guide.

3. The light-emitting keyboard according to claim 1, wherein the light entrance surface and the bottom surface of the light guide adjoin to each other and the bottom surface of the light guide is opposed to the light exit surface of the light guide such that the light originated from the light source enters at the light entrance surface of the light guide and radiates out of the light guide via the light exit surface thereof.

4. The light-emitting keyboard according to claim 1, wherein the second opening is a conical opening, the conical surface of the second opening being coated with the light reflecting material.

5. The light-emitting keyboard according to claim 4, wherein the light reflecting material is printed on or formed integrally with the conical surface of the second opening.

6. The light-emitting keyboard according to claim 1, wherein the light guide further comprises a first lateral side, a second lateral side and a third lateral side, the first and third lateral sides being perpendicular to the light entrance surface of the light guide and the second lateral side being parallel to the light entrance surface of the light guide; wherein the first, second and third lateral sides are coated with a light reflecting material.

7. The light-emitting keyboard according to claim 6, wherein the light reflecting material is printed on or formed integrally with the first, second and third lateral sides.

8. A light-emitting keyboard, comprising:
a light guide having a light entrance surface, a bottom surface and a light exit surface;
a light source provided on one side of the light entrance surface of the light guide;
a membrane circuit board disposed on top of the light guide;
an elastic contact body provided on the membrane circuit board;
a supporting plate disposed on top of the membrane circuit board, the supporting plate further including a first opening corresponding to the elastic contact body and a plurality of first and second fixation brackets adjacent to the first opening thereon;
a scissor assembly engaged with the supporting plate and disposed thereon; and
a keycap supported by the scissor assembly;
wherein the bottom surface and the light exit surface of the light guide are coated with a light reflecting material such that the bottom surface of the light guide reflects the light originated from the light source to enter the light guide and the light exit surface of the light guide permits a portion of the light emitted therefrom to pass therethrough and reflects another portion of the light back towards the light guide; and wherein the light guide is provided with a second opening corresponding to the elastic contact body, the circumference of the second opening of the light guide being coated with a light reflecting material.

9. The light-emitting keyboard according to claim 8, wherein the light source is controlled by a base circuit board and provided adjacent to a lateral side of the light guide.

10. The light-emitting keyboard according to claim 8, wherein the light entrance surface and the bottom surface of the light guide adjoin to each other and the bottom surface of the light guide is opposed to the light exit surface of the light guide such that the light originated from the light source enters at the light entrance surface of the light guide and radiates out of the light guide via the light exit surface thereof.

11. The light-emitting keyboard according to claim 8, wherein the second opening is a conical opening, the conical surface of the second opening being coated with the light reflecting material.

12. The light-emitting keyboard according to claim 11, wherein the light reflecting material is printed on or formed integrally with the conical surface of the second opening.

13. The light-emitting keyboard according to claim 8, wherein the light guide further comprises a first lateral side, a second lateral side and a third lateral side, the first and third lateral sides being perpendicular to the light entrance surface of the light guide and the second lateral side being parallel to the light entrance surface of the light guide; and wherein the first, second and third lateral sides are coated with a light reflecting material.

14. The light-emitting keyboard according to claim 13, wherein the light reflecting material is printed on or formed integrally with the first, second and third lateral sides.

15. The light-emitting keyboard according to claim 8, wherein the light reflecting material is printed on or formed integrally with the bottom surface and the light exit surface of the light guide.
